(19) United States
(12) Patent Application Publication
(10) Pub. No.: US 2009/0250918 A1
(43) Pub. Date: Oct. 8, 2009

(54) Book

(76) Inventor: Maximilian R. Seidl, Munich (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/383,984

(22) Filed: Mar. 31, 2009

(30) Foreign Application Priority Data
Apr. 8, 2008 (DE) 20 2008 004 862.1

(51) Int. Cl. B42D 3/00; B42F 13/00

(52) U.S. Cl. 281/29; 402/75

(57) ABSTRACT

A book has a top book cover, a bottom book cover and a spine as well as a least two separate rings secured to the spine and/or to one of the book covers for threading on sheets, the rings each having a slot for the introduction of sheets, and the separate rings are of rigid construction and are individually fastened, secured against rotation, to the spine and/or to one of the book covers. The rings furthermore have an inwardly projecting bearing surface for threaded-on sheets, the bearing surface being designed so that the bottom sheet in each case, on both sides of the opened book, rests on the bearing surface with its edge region protruding into the ring.

### FIELD OF THE INVENTION

The invention relates to a book having a top book cover, a bottom book cover and a spine as well as at least two separate rings secured to the spine and/or to one of the book covers for threading on sheets of paper.

### BACKGROUND OF THE INVENTION

A wide variety of books, binders, files and the like are commercially available, which permit separate pages to be individually compiled. In the case of what is known as spiral wire binding, however, the subsequent insertion of new pages is impossible. For such applications, ring binders or ring files are used. These storage options are generally perceived to be very advantageous.

An especially simple form for keeping together several sheets are spring-back files. With these spring-back files, the spine is formed by a clamping strip pushed on from the outside. This construction has the disadvantage, however that the pages can no longer be opened out completely and consequently the opened-out pages are relatively badly bent. These bent pages then mostly have the undesirable tendency to close by themselves if they are not held onto or weighted down.

For special applications, for example, for photograph albums or in particular for impressive presentation folders, however, there is in many cases a desire for an aesthetically appealing new system.

DE 20 2006 019 365, for example, discloses a book having a top book cover, a bottom book cover and a spine as well as at least two separate rings secured to one of the book covers and/or to the spine for threading on printed sheets, each ring consisting of two rigid parts that are detachably connected to one another at at least a first connecting point for repeated opening and closing of the ring. In this way, the separate sheets can be compiled individually and a subsequent exchange of individual pages is also possible.

U.S. Pat. No. 5,154,528 likewise describes a book, where the bottom book cover has screwed to it a plurality of separate rings onto which sheets are threaded. The individual rings are of flexible construction and can be bent open for insertion and removal of individual sheets, the rings consistently returning to their original annular shape. Normally, two or more rings are provided, so that the insertion of further sheets proves relatively complicated, as each ring has to be bent open separately by hand.

In GB-A-587 108, a plurality of retaining hooks are provided, which are fixed by means of a common base plate to the bottom book cover. The hooks have relatively large slots or openings, which can be closed by a common closure plate. By virtue of the fact that the hooks are arranged at a predetermined spacing on a common base plate, books can be produced only in quite specific formats. In addition, the closure plate means that another part is required. In contrast, separate rings have the advantage that they can be used for any formats and moreover require a much lower outlay on material.

DE 1 744 850 discloses a ring mechanism in which likewise a plurality of hooks is secured to a base plate or is machined from this base plate. Once the sheets have been threaded on, this ring mechanism can be secured to or pushed into a bottom book cover of a book. Here too, the base plate constitutes an additional outlay on material compared with separate rings. A further ring mechanism is described in FR-A-876 245, where again a plurality of rings is mounted on a common mounting plate. This mounting plate is affixed to the spine, the spine being foldable approximately in its middle in order to permit sheets to be threaded on and removed. In addition to the common mounting plate, this construction also has the drawback that because the spine is separable, the threaded-on sheets can easily inadvertently slip out.

### SUMMARY OF THE INVENTION

The invention therefore addresses the problem of producing a book that requires little outlay on material, yet allows a simple handling when threading on and taking out the sheets.

According to the invention, the above problem is solved by the features of claim 1.

The invention also addresses the problem of ensuring that the threaded-on sheets are securely held against accidental slipping out. Furthermore, compared to conventional ring binders, a relatively slim construction is to be afforded, which also has an aesthetically pleasing appearance.

The book according to the invention comprises a top book cover, a bottom book cover and a spine as well as at least two separate rings secured to the spine and/or to one of the book covers onto which sheets can be threaded, the rings each having a slot for the insertion of sheets and the separate rings being of rigid construction and being individually fixed, secured against rotation, to the spine and/or to one of the book covers. The rings furthermore have an inwardly projecting bearing surface for threaded-on sheets, the bearing surface being designed so that the bottom sheet in each case, on both sides of the opened book, rests on the bearing surface with its edge region protruding into the ring.

The arrangement of the rings secured against rotation enables the slots of the rings to be aligned in the same direction, so that sheets can be simultaneously inserted into all rings without problems. The special construction of the bearing surface ensures a reliable support for the threaded-on sheets.

The provision of a top book cover, a bottom book cover and a spine produces an aesthetically pleasing external form.

Further features of the invention form the subject matter of the subsidiary claims.

The separate rings are preferably of one-piece construction and may have an oval form. According to an advantageous construction of the invention, the inwardly projecting bearing surface extends over an angle range of 60° ±20°, thus ensuring a sufficiently large area.

According to a first exemplary embodiment, the bottom book cover is provided with openings, into which the rings for fixing to the book cover can be inserted. For that purpose, the rings may have two opposite rectilinear grooves separated by a bridge, wherein the rings are of flat construction in the region having the grooves and this region, on its inwardly facing side, can form the bearing surface.

The openings are expediently formed in at least one further layer of the bottom book cover. This further layer is arranged at least in the region of the book spine and has an edge region aligned parallel thereto, in which the openings terminate. This edge region can be formed, for example, by doubling back or folding the bottom book cover.

According to a further construction of the invention, the openings are elongated and provided with at least one indentation, the rings being provided in the region of the grooves with at least one projection of complementary form, which co-operates with the indentation. In this connection, at least one projection can be arranged so that initially the ring is introduced until the projection comes into contact with the indentation in the book cover, thereby defining the position for threaded on or removing sheets, and the at least one projection, as the ring is pushed in further, comes into operative contact with the at least one indentation, thereby defining the end position of the rings.

In a further construction of the invention, the two grooves are bounded by a top part of flat construction and a bottom part of flat construction, the top part and bottom part being connected to one another by a bridge and the inwardly facing side of the top part forming the bearing surface. The bottom part can preferably be at least twice as wide as the top part, in order to facilitate introduction of the ring and to ensure a firm support for the rings.

According to a further exemplary embodiment of the invention, in the closed state of the book the slot in the rings is aligned so that it opens out in the transition region between spine and one of the two book covers, the slot being unblocked for threading on or exchanging sheets when the bottom book cover is turned over with respect to the top book cover opposite to the usual direction of closing the book.

### BRIEF DESCRIPTION OF THE DRAWINGS

Further advantages and constructions of the invention are explained in detail in the following by means of the description and the drawings, in which:

FIG. 1 shows a plan view of an opened book according to a first exemplary embodiment,

FIG. 2a shows a side view of a ring,

FIG. 2b shows a sectional view of the ring along the line A-A of FIG. 2a,

FIG. 2c shows a sectional view of the ring along the line B-B of FIG. 2a,

FIG. 2d shows a sectional view of the ring along the line C-C of FIG. 2a,

FIG. 3 shows a plan view of the sheet of material for producing the top book cover, spine and bottom book cover,

FIG. 4a shows a side view of the closed book according to FIG. 1,

FIG. 4b shows a side view of the opened book according to FIG. 1,

FIG. 4c shows a side view of the opened book in which the ring has been displaced into a position for threading on and removing the sheets,

FIG. 4d shows a side view of the opened book in which the slot in the rings is unblocked for threading on or removing sheets,

FIGS. 5a-5c show schematic side views of different exemplary embodiments of top book cover, spine and bottom book cover,

FIG. 6 shows a plan view of an opened book according to a second exemplary embodiment,

FIG. 7 shows a side view of a ring of the second exemplary embodiment,

FIG. 8 shows a side view of the opened book according to the second exemplary embodiment,

FIG. 9 shows a side view of the closed book according to the second exemplary embodiment,

FIG. 10 shows a side view of the book according to the second exemplary embodiment as a sheet is being threaded on, and

FIG. 11 shows a side view of the opened book according to the second exemplary embodiment with a closure sheet.

### DETAILED DESCRIPTION OF ILLUSTRATIVE EMBODIMENTS

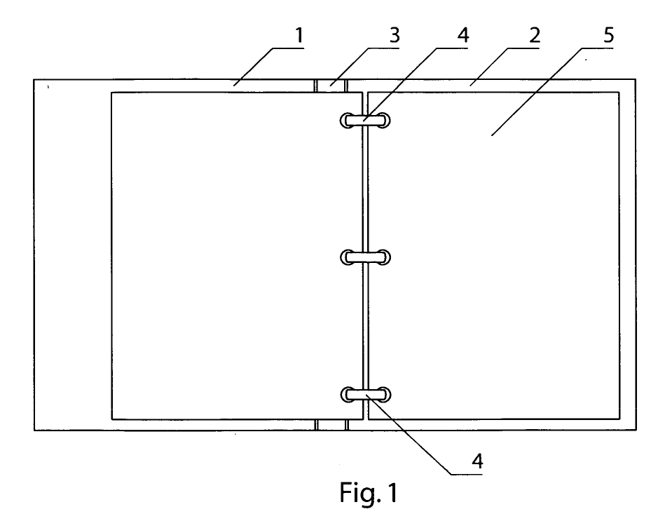

FIG. 1 shows a book according to a first exemplary embodiment of the invention, which substantially comprises a top book cover 1, a bottom book cover 2 and a spine 3, and for threading on sheets 5, a plurality of separate rings 4 secured to the bottom book cover.

The two book covers and the spine are advantageously produced from one sheet of material, the flexibility between the book covers and the spine being ensured by suitable punchings or groovings. The spine itself is rigid, or at least not of foldable construction. All likely materials, for example, cardboard, leather, plastics material or metal, can be considered for the book.

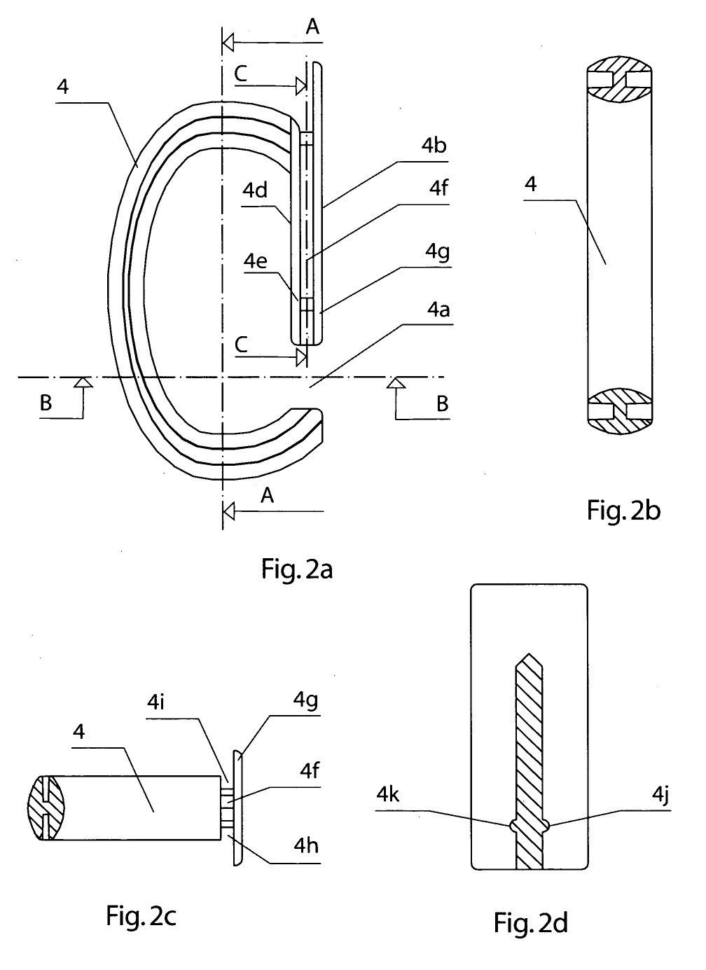

The rings 4 are illustrated in detail in FIGS. 2a to 2d. They are one-piece, rigid, and of closed construction except for a slot 4a. Suitable materials are, for example, plastics material or metal.

The rings 4 are oval in shape and on one of their longer sides have an inwardly projecting bearing surface 4d. The bearing surface 4d is formed on a flat top part 4e of the ring. This flat top part is connected to a flat bottom part by a bridge 4f, so that two opposite rectilinear grooves 4h, 4i (FIG. 2c) separated from one another by the bridge 4f are produced. The bottom part 4g is substantially wider than, preferably twice as wide as, the top part 4d.

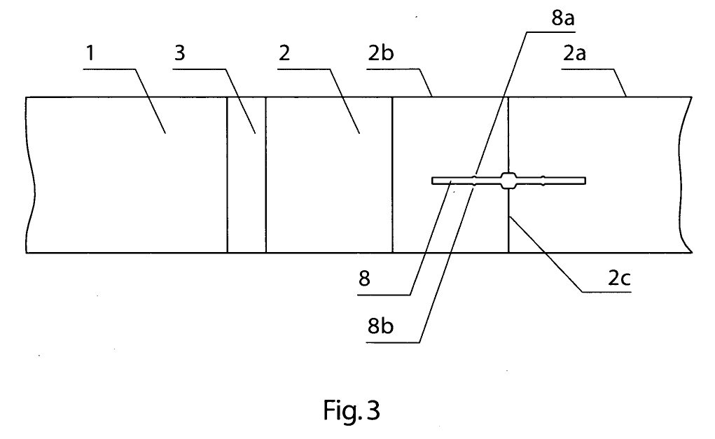

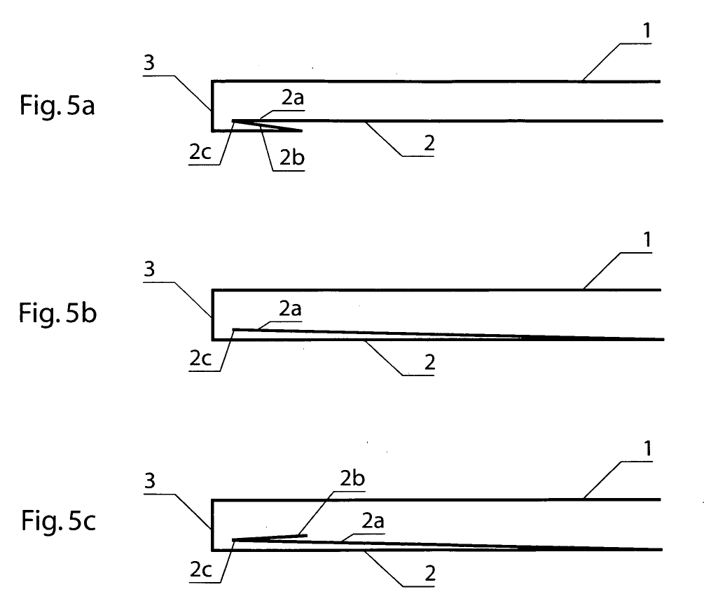

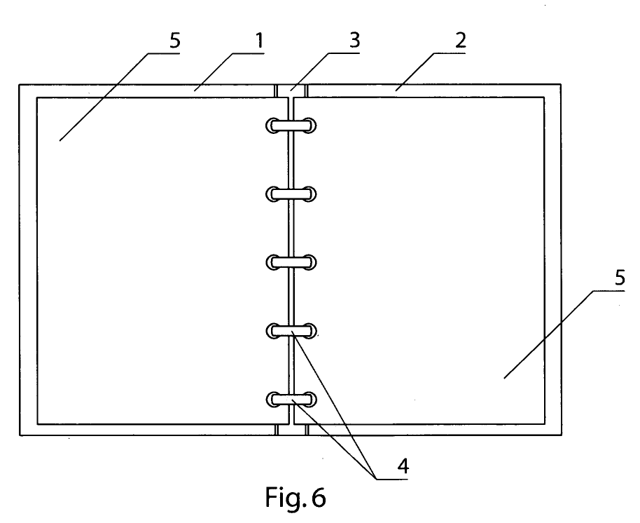

At the points where the rings 4 are to be mounted, the bottom book cover 2 has openings 8 (FIG. 3), into which the rings 4 can be inserted in the region of their grooves 4h, 4i. The opening 8 is here preferably provided in at least one further layer 2a, 2b of the bottom book cover 2. According to the exemplary embodiment shown in FIGS. 3 and 5a, in the region of the openings 8 two further layers 2a, 2b are provided, which are formed by a double fold. In this way, an edge region 2c is formed, which is arranged in the region of the spine and aligned parallel to it. The openings 8 are then constructed so that they open out into this edge region 2c.

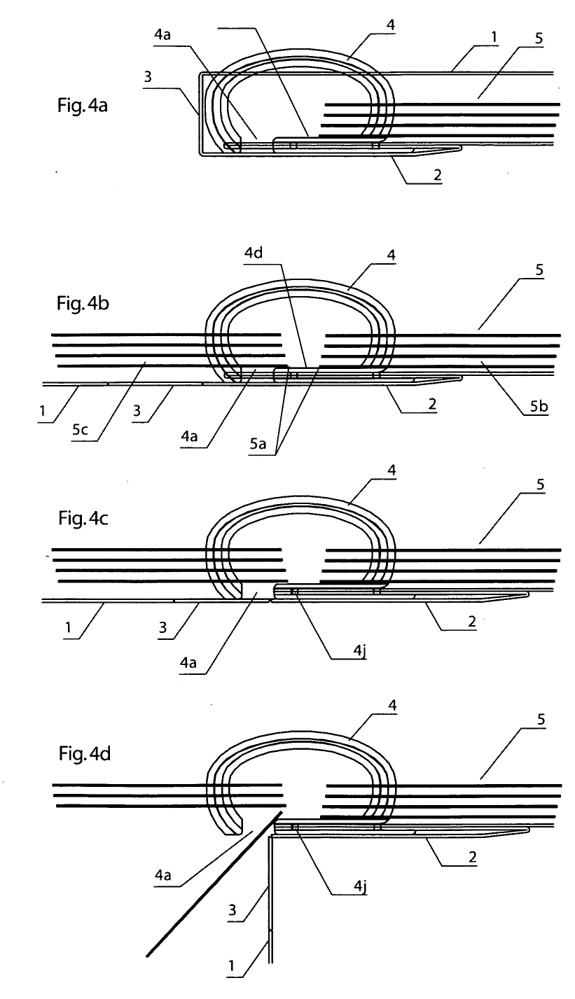

The illustrations according to FIG. 4a-4d show the ring 4 in positions partially or wholly pushed into the opening 8. In FIG. 4a, the ring 4 is pushed in completely and the book is in its closed position. The slot 4a for threading on and removing the sheets 5 is closed by the bottom book cover 2. In the open state shown in FIG. 4b, the slot 4a is also masked, so that the sheets 5 cannot slip out. Furthermore, the bearing surface 4d is designed so that the bottom sheets 5b, 5c on respective sides of the open book rest on the bearing surface 4d with their edge region 5a projecting into the ring 4.

In order subsequently to exchange individual or all sheets or to insert new sheets, the ring 4 is displaced in the opening 8 from the position shown in FIG. 4b into the position shown in FIG. 4c. The top book cover 1, together with the spine 3, is then folded down, for example, over a table edge, or folded round as far as the bottom book cover 2 so that the slot 4a is unblocked. After the sheets 5 have been threaded on or removed, the rings 4 are pushed right into the openings again, so that the slot 4a is again masked by the bottom book cover 2.

So that the further layers 2a, 2b of the bottom book cover in the vicinity of the edge region 2c do not form a bulge impairing the insertion of the rings, the fold is expediently produced by a cut on the outer bend, which extends through approximately 50 to 70% of the thickness of the material. In addition, the further layers 2a, 2b could be adhesively secured at selected points or over two-dimensional areas to one another and/or to the bottom book cover 2, in which case there must naturally be no adhesion with the bottom book cover 2 in the region of the openings 8, so that the bottom part 4g of the ring 4 can be introduced between the further layer 2b and the bottom book cover 2.

According to a further construction of the invention, the openings 8 are provided with at least one notch, preferably with at least a pair of opposite notches 8a, 8b (see FIG. 3). These notches co-operate with projections 4j, 4k of complementary construction in the region of the grooves 4i, 4h. The projections 4j, 4k are here arranged so that initially the ring 4 is introduced into the openings 8 only until the projections come into contact with the opening 8, whereby the position for threading on or removing sheets is defined (FIG. 4c and FIG. 4d). As the rings 4 are pushed in further, the projections 4j, 4k press the opening 8 apart a little until they come into operative contact with the notches 8a, 8b, whereby the end position of the rings is defined. In this way, a secure hold of the rings 4 in the openings 8 is ensured. Alternatively, however, by correct choice of the groove width in relation to the thickness of the book cover material in the region of the openings, the notches and projections could be omitted.

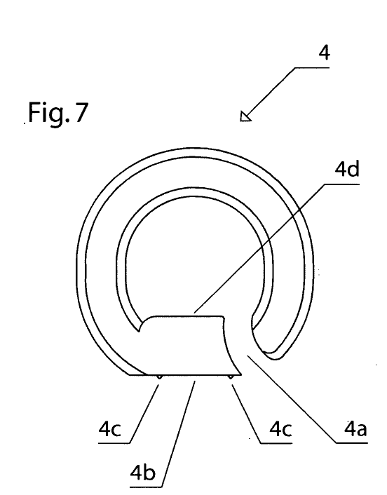

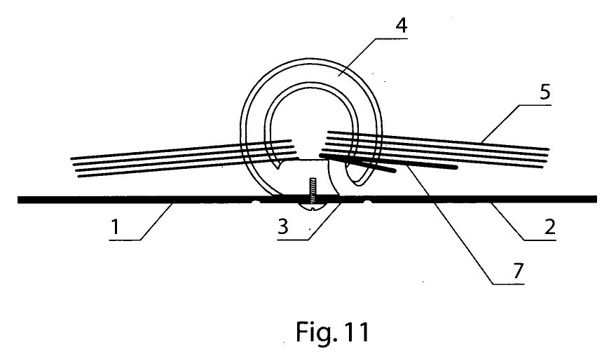

In FIGS. 7 to 11, a book according to a second exemplary embodiment is illustrated. For ease of understanding, the same reference numerals have been used for similar parts. Accordingly, the Figures illustrate a book having a top book cover 1, a bottom book cover 2, a spine 3 as well as a plurality of separate rings 4 secured to the spine and/or to one of the book covers for threading on sheets 5.

The two book covers and the spine are advantageously produced from one sheet of material, the flexibility between the book covers and the spine being ensured by suitable punchings or groovings. The spine itself is rigid, or at least not of foldable construction. All likely materials, for example, cardboard, leather, plastics material or metal, can be considered for the book.

The rings 4 are one-piece, and of closed construction except for a slot 4a. Suitable materials are, for example, plastics material and metal.

Furthermore, the rings have contact surface 4b of flat construction, with which in the exemplary embodiment illustrated they come into contact with the spine 3 for fastening purposes.

The fastening itself can be effected by screw connection, rivetting or adhesion. It would also be possible for the ring to be mounted, secured against rotation, in an opening of the spine.

In the second exemplary embodiment, the rings are fastened by means of screws 6. The contact surface 4b can additionally have retaining pins 4c, which partially penetrate the spine 3 during fastening and prevent twisting during the fastening operation and during normal use of the book.

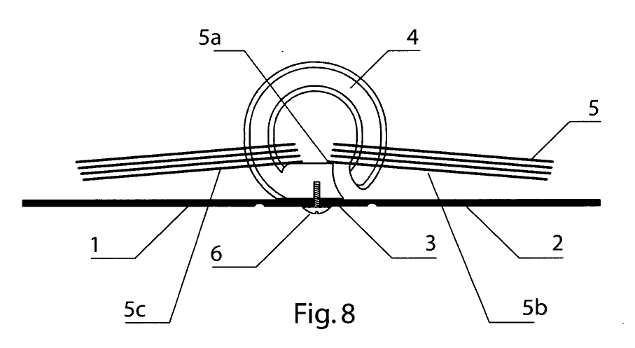

In the region of the ring 4 where the contact surface 4b is provided on the outside, the ring has on its inside an inwardly projecting bearing surface 4d. Both the contact surface 4b and the bearing surface 4d are advantageously substantially level and allow each bottom sheet 5b, 5c (FIG. 8) on both sides of the open book to rest with its edge region 5a projecting into the ring on the bearing surface 4d, and thereby prevent inadvertent slipping out.

The slot 4a is arranged so that it opens out directly at the edge of the contact surface 4b. As can be seen especially from FIG. 8, the bottom sheet 5 lies, with its edge region 5a projecting into the ring 4, on the bearing surface 4d. The bearing surface 4d thus prevents the sheets from being able to slide further down towards the slot 4a.

In the exemplary embodiment illustrated, the slot is arcuate. The size of bearing surface 4d, the orientation of the slot 4a and the width of the slot are coordinated with one another so that, on the one hand, one or more sheets can be simultaneously introduced into the slot for the purpose of threading onto the rings and, on the other hand, during normal turning over of the sheets, the inserted sheets are prevented from slipping out in an undesirable manner.

The rings may in principle have any suitable form that allows the sheets to be turned over without problems. Substantially circular or oval forms are suitable here.

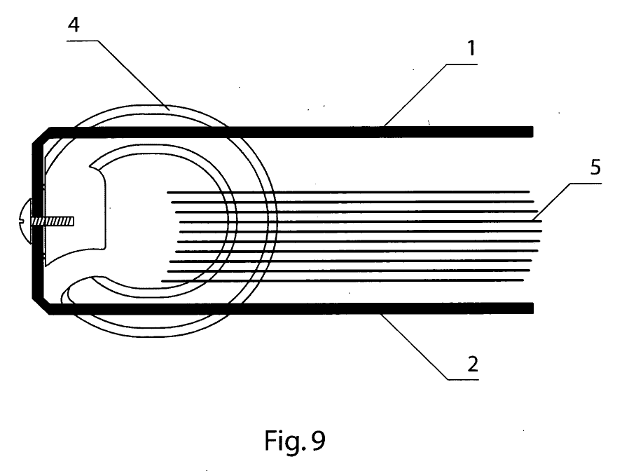

In the exemplary embodiment illustrated, the ring 4 is of slightly elongate form, and is secured to the spine 3 with its narrower side. This has the advantage that in its closed state the entire book is somewhat slim yet nevertheless as many sheets as possible can be threaded on. If the top and the bottom book cover 1, 2 are provided in the region of the rings 4 with openings (FIG. 9), in the closed state of the book the rings are able to protrude partially through the top and bottom book covers. In this way, with a predetermined number of insertable sheets, the book can be extremely slim since the thickness of the book covers is not additionally bulky.

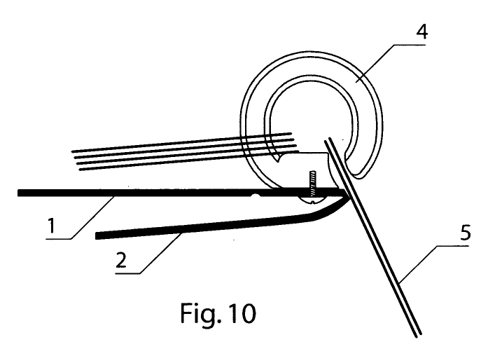

Advantageously, the slot 4a is oriented towards the spine 3, namely towards the side to which the bottom book cover is joined. When sheets are threaded on or exchanged, the bottom book cover is turned relative to the top book cover in a direction opposite to the normal direction in which the book is closed (FIG. 10), so that the slot 4a is unblocked. Sheets, which are provided with openings at the spacing of the rings, can thus be introduced into the slots of the rings. Depending on the width of the slot, several sheets at a time can be introduced. Once all sheets have been threaded on, the bottom book cover is folded back again.

In the trials on which the invention is based, it was shown that as far as relatively thick sheets are concerned, the sheets do not slip out inadvertently. In the case of thinner sheets, for example, of a material thickness of 70-100 g/m², it may be helpful as a final step to thread on a closure sheet 7, which is elongate and flat and has a front edge bent in a V-shape and provided with openings for threading onto the rings. Even in the case of relatively thin sheets, the sheets are prevented from accidentally slipping out by this closure sheet.

The books described above offer an extremely aesthetic system of compiling and filing separate sheets individually. The opportunity is there to stand out from the conventional, rather unappealing ring binders and folders, and accordingly spark the viewer's interest.

Moreover, threading on and removing sheets is simple, yet inserted sheets are reliably held.

Possible applications include photograph albums and presentation folders.{BOILERPLATE} In light of the foregoing, it should be appreciated that the present invention significantly advances the art by providing a ______ that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A book including a plurality of sheets of paper comprising:
a top book cover;
a bottom book cover;
a spine;
at least two separate rings for threading the plurality of sheets of paper thereon, said rings being secured to a member selected from said spine, said top book cover and said bottom book cover, said rings each having a slot for the introduction of sheets, wherein said rings are of rigid construction and are individually fastened, secured against rotation, to said member, and said rings have an inwardly projecting bearing surface designed so that, when the book is opened such that the plurality of sheets of paper thereof are caused to form two stacks, the bottom sheet in each such stack rests on said inwardly projecting bearing surface and presents an edge region protruding into said rings.

2. A book according to claim 1, wherein said rings are of one-piece construction.

3. A book according to claim 1, wherein said inwardly projecting bearing surface extends over an angle range of from 400 to 800.

4. A book according to claim 1, wherein said rings are oval.

5. A book according to claim 1, wherein said bottom book cover is provided with openings into which said rings are inserted.

6. A book according to claim 5, wherein said rings have two opposite rectilinear grooves separated from one another by a bridge.

7. A book according to claim 6, wherein said rings are of flat construction in the region having said rectilinear grooves, and this region, on an inwardly facing side thereof, forms said bearing surface.

8. A book according to claim 5, wherein said bottom book cover includes multiple layers, and said openings are formed in more than one of said multiple layers of said bottom book cover.

9. A book according to claim 8, wherein one of said multiple layers is arranged in the region of said spine and, aligned parallel thereto, provides an edge region, in which said openings terminate.

10. A book according to claim 9, wherein said edge region is formed by a fold in said bottom book cover.

11. A book according to claim 6, wherein said openings are elongate and provided with at least one notch, and said rings are provided in the region of said rectilinear grooves, said rings including at least one projection of complementary form to said at least one notch such that said at least one projection is received at said at least one notch.

12. A book according to claim 11, wherein said at least one projection is arranged so that initially said rings are introduced only until said at least one projection comes into contact with said opening, whereby a position for threading on or removing sheets is defined, and, as said rings are pushed in further, said at least one projection comes into operative contact with the at least one notch, whereby the end position of said rings is defined.

13. A book according to claim 5, wherein said rectilinear grooves are bounded by a top part of flat construction and a bottom part of flat construction, said top part and said bottom part being connected to one another by said bridge, and an inwardly facing side of said top part forming said bearing surface.

14. A book according to claim 13, wherein said bottom part is at least twice as wide as said top part.

15. A book according to claim 1, wherein, when the book is closed, said slots open out in a transition region between said spine and one of said top book cover and said bottom book cover, said slots being unblocked for threading on or exchanging sheets when said bottom book cover is turned with respect to said top book cover opposite to the usual direction of closing the book.
